(19) United States
(12) Patent Application Publication
(10) Pub. No.: US 2013/0313297 A1
(43) Pub. Date: Nov. 28, 2013

(54) MOBILE DEVICE HOLDER

(71) Applicant: WINSTON PRODUCTS LLC, Cleveland, OH (US)

(72) Inventors: Christopher O'Hara Belby, Breckenridge, CO (US); William Scott Smith, Breckenridge, CO (US)

(73) Assignee: WINSTON PRODUCTS LLC, Cleveland, OH (US)

(21) Appl. No.: 13/895,456

(22) Filed: May 16, 2013

Related U.S. Application Data
(60) Provisional application No. 61/649,967, filed on May 22, 2012.

(51) Int. Cl. B62B 5/00

(52) U.S. Cl. CPC B62B 5/00
USPC 224/411

(57) ABSTRACT

A holding device is attachable to a shopping cart. The holding device includes a base portion attached to a cart handle of the shopping cart and a pair of adjustable slides movably attached with respect to the base portion. The adjustable slides define an interior portion for receiving a mobile device. The holding device includes at least one adjustment device positioned within the base portion and attached to each of the adjustable slides. The at least one adjustment device biases the adjustable slides towards each other so as to support the mobile device between the adjustable slides.

### RELATED APPLICATIONS

This application claims the benefit of U.S. Provisional Application No. 61/649,967, filed on May 22, 2012, the entire disclosure of which is hereby incorporated herein by reference.

### BACKGROUND OF THE INVENTION

1. Field of the Invention

The present invention relates generally to a holding device for supporting a mobile device on a shopping cart.

2. Discussion of the Prior Art

Mobile devices, including cellular phones, are known and used in many different applications. A shopper can use his/her mobile device, for example, to search for coupons or advertisements at a particular store. Indeed, it is not uncommon for shoppers to push/manipulate a shopping cart while simultaneously holding a mobile device to manually search for coupons or advertisements. This concurrent holding and manipulation of both the shopping cart and the mobile device can cause a number of problems, including dropped/broken mobile devices, inattentive shoppers, or the like. Accordingly, there is a need and it would be beneficial to provide a holding device for attachment to a shopping cart, in which the holding device can support a mobile device.

### BRIEF DESCRIPTION OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect, the present invention provides a holding device for attachment to a shopping cart. The holding device includes a base portion attached to a cart handle of the shopping cart. The holding device includes a pair of adjustable slides movably attached with respect to the base portion. The adjustable slides define an interior portion configured to receive a mobile device. The holding device includes at least one adjustment device positioned within the base portion and attached to each of the adjustable slides. The at least one adjustment device can bias the adjustable slides towards each other so as to support the mobile device between the adjustable slides.

In accordance with another aspect, the present invention provides a holding device for attachment to a shopping cart. The holding device includes a base portion. The holding device includes a pair of adjustable slides movably attached with respect to the base portion. The adjustable slides define an interior portion configured to receive a mobile device. The holding device includes at least one adjustment device attached to each of the adjustable slides and being configured to bias the adjustable slides towards each other. The holding device includes at least one securing device movably attached with respect to the base portion. The at least one securing device receives a cart handle of the shopping cart to attach the base portion to the cart handle.

In accordance with another aspect, the present invention provides a shopping cart including a base portion integrally formed with a cart handle of the shopping cart. The shopping cart includes a pair of adjustable slides movably attached with respect to the base portion. The adjustable slides define an interior portion configured to receive a mobile device. The shopping cart includes at least one adjustment device positioned within the base portion and attached to each of the adjustable slides. The at least one adjustment device can bias the adjustable slides towards each other.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 illustrates a perspective view of an example holding device supporting a mobile device in a portrait orientation and being attached to an example shopping cart;

FIG. 2 illustrates a perspective view of the example holding device in a detached/separated state from the shopping cart;

FIG. 3 illustrates a rear perspective view of the example holding device;

FIG. 4 illustrates a rear perspective view of the example holding device in which securing devices are in a closed position and adjustable slides are separated/moved apart from each other;

FIG. 5 illustrates an example adapter structure for assisting the attachment of the holding device to the shopping cart;

FIG. 6 illustrates a side view of FIG. 5 of the adapter structure being supported within an interior portion of the holding device;

FIG. 7 illustrates a perspective view of the holding device of FIG. 1 but with the mobile device being supported in a landscape orientation: and

FIG. 8 illustrates a perspective view of a second example holding device that is molded to the shopping cart.

### DETAILED DESCRIPTION OF THE INVENTION

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

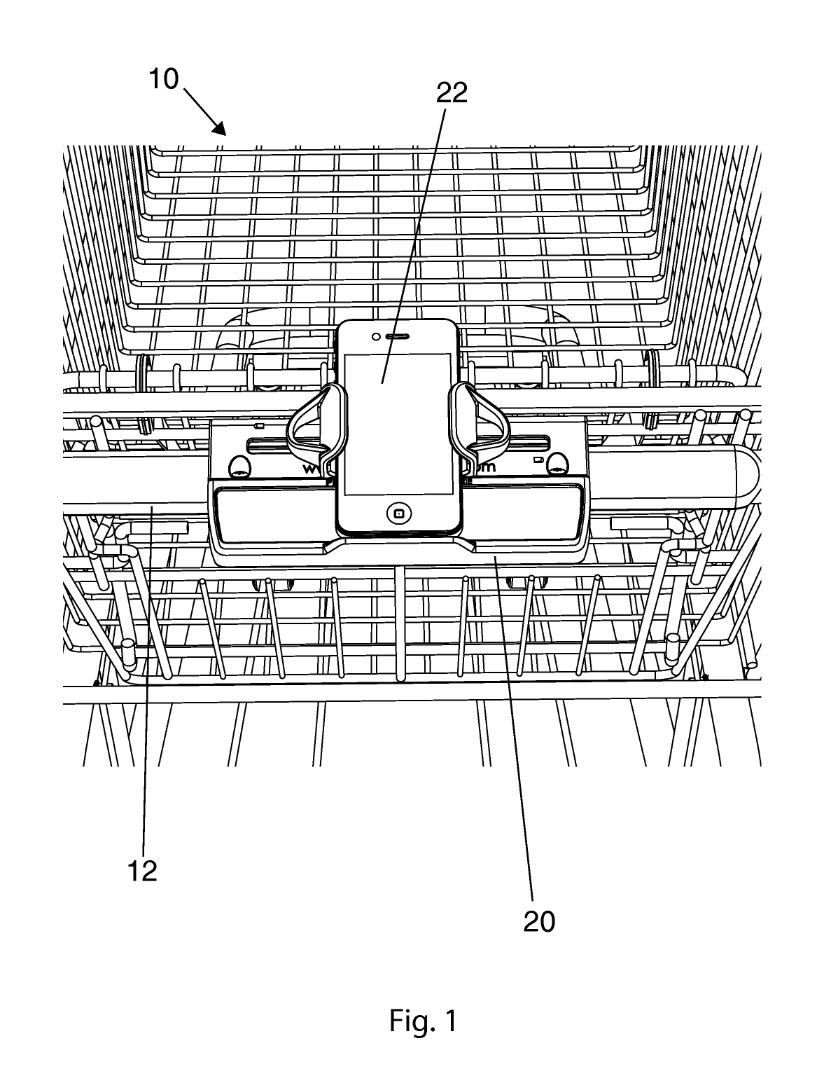

Referring to FIG. 1, a shopping cart 10 is illustrated as an environment/structure within which the present invention may be utilized. It is to be appreciated that FIG. 1 merely illustrates one example of the possible structure/configuration of the shopping cart 10, and that other examples are contemplated. In general, the shopping cart 10 can be used for supporting/transporting items in a shopping environment. The shopping cart 10 can be used in any number of shopping environments, including grocery stores, malls, warehouses, clothing stores, home improvement stores, or the like.

The shopping cart 10 is somewhat generically/schematically illustrated as the shopping cart 10 includes any number of sizes, shapes, and constructions. In one example, the shopping cart 10 can include a basket area for receiving the items therein. The shopping cart 10 may also include a cart handle 12. The cart handle 12 in this example is a generally linearly extending structure that a user/shopper can grip to manipulate and/or move the shopping cart 10. Of course, the cart handle 12 is not limited to the illustrated example, and, instead, could include any number of sizes/shapes, such as by having a larger/smaller cross-sectional size, extending along a non-linear axis, or the like.

A holding device 20 can be attached with respect to the shopping cart 10. In the illustrated example, the holding device 20 can be attached to the cart handle 12, such that the holding device 20 is supported by the cart handle 12. The holding device 20 is somewhat generically/schematically depicted, as a number of different constructions, sizes, shapes, etc. are envisioned. In general, the holding device 20 can support a mobile device 22. The mobile device 22 can include, for example, mobile phones, tablet devices, computing devices, or the like. In one example, the holding device 20 can support the mobile device 22 in a portrait orientation (as illustrated) or a landscape orientation. In addition, the holding device 20 can also support an advertisement that can display advertisements, coupons, matrix barcodes (e.g., QR codes, etc.).

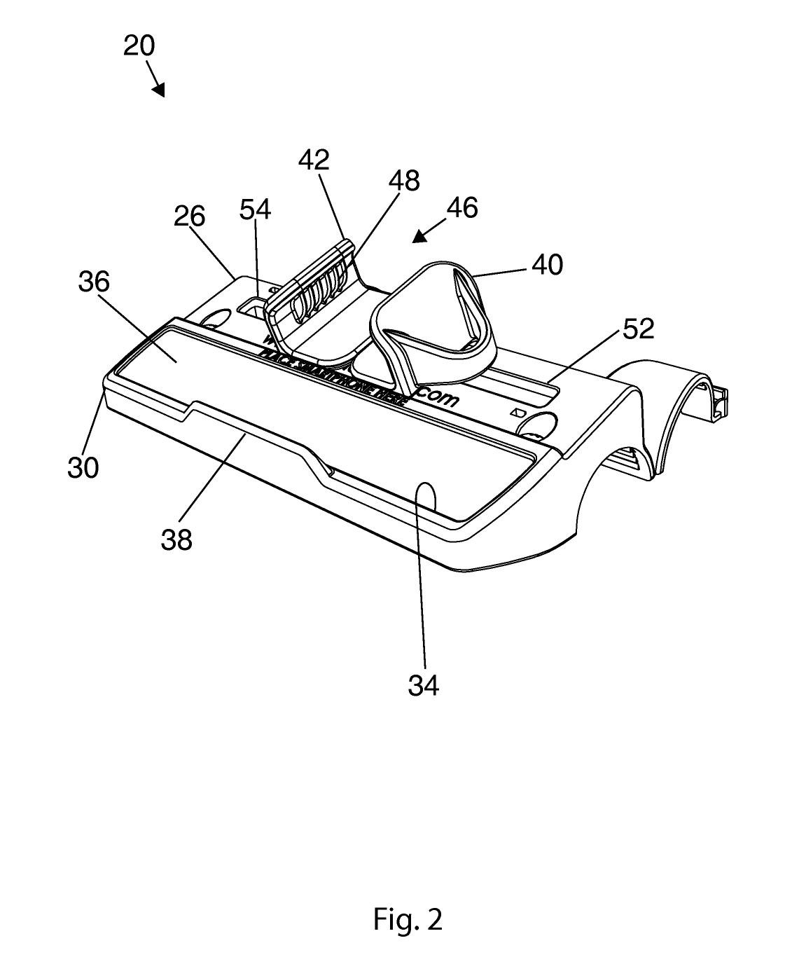

Turning now to FIG. 2, an example of the holding device 20 is illustrated. It is to be appreciated that the holding device 20 is illustrated in a detached/separated state from the shopping cart 10 for illustrative purposes and to more clearly illustrate the structure of the holding device 20. In operation, however, the holding device 20 can be arranged in a similar manner as described above with respect to FIG. 1.

The holding device 20 can include a base portion 26. The base portion 26 extends along a longitudinal axis that is generally parallel with respect to the cart handle 12. The base portion 26 is an elongated structure that extends a distance along the cart handle 12. The base portion 26 can include a generally rectangular shape, though other sizes and shapes are envisioned. For example, the base portion 26 can include a square shape, rounded shape, oval shape, rectangular shape with rounded edges, etc.

The base portion 26 can include a supporting portion 30. The supporting portion 30 extends substantially entirely along the length of the base portion 26, such that the supporting portion 30 extends generally parallel with respect to the cart handle 12. The supporting portion 30 defines a generally rectangular shape, though other shapes are envisioned. In one example, the supporting portion 30 defines a recess 34 that can receive/support a placard 36. The placard 36 can include any different types of information, including advertisements, coupons, text-based information, or the like. In other examples, the placard 36 can include barcodes, matrix barcodes, QR codes, or the like. Indeed, the placard 36 is not limited to displaying the aforementioned information, and could likewise display other types of information/graphics as well. The placard 36 can be selectively removed from the recess 34, such as by means of a keying structure, or the like. In other examples, the placard 36 can be slidably inserted or removed from the recess 34.

The base portion 26 can include an extension 38. The extension 38 can protrude outwardly from the recess 34. The extension 38 can define a ledge, wall, protrusion, or the like. In one example, the extension 38 extends in a direction that is generally perpendicular to a surface of the base portion 26. In other examples, however, the extension 38 is not so limited. The extension 38 in this example extends a shorter distance in length than the base portion 26, but in other examples, could extend a longer or shorter distance than as shown. In one example, the extension 38 can contact/engage the mobile device 22 when the mobile device 22 is supported by the holding device 20. This contact/engagement between the mobile device 22 and the extension 38 can limit the likelihood of the mobile device 22 from inadvertently falling from the holding device 20.

The holding device 20 can include a pair of adjustable slides that are movably attached with respect to the base portion 26. In one example, the adjustable slides include a first adjustable slide 40 and a second adjustable slide 42. The first adjustable slide 40 and second adjustable slide 42 can, together, define an interior portion 46 into which the mobile device 22 can be inserted and supported. The interior portion 46 is disposed between the first adjustable slide 40 and second adjustable slide 42. In one example, the adjustable slides (including some, or all, of the holding device 20) can be formed from components including an antimicrobial plastic.

The first adjustable slide 40 and second adjustable slide 42 can each extend outwardly in a direction away from the base portion 26. In one example, the first adjustable slide 40 and second adjustable slide 42 can include a ledge, shoulder, or the like positioned at an outermost location from the base portion 26 to assist in supporting/holding the mobile device 22. The first adjustable slide 40 and second adjustable slide 42 can each include gripping structures 48 positioned on interior surfaces of the adjustable slides that face the interior portion 46. The gripping structures 48 can include rubber, a thermoplastic elastomer, or a similar flexible, elastomeric material that allows for the gripping structures 48 to grip/hold opposing edges of the mobile device 22. As such, the mobile device 22 is generally limited from unintended movement, such as in a direction away from the base portion 26, etc.

The first adjustable slide 40 and second adjustable slide 42 can each be supported within one or more openings within the base portion 26. For example, the first adjustable slide 40 can be positioned at least partially within a first opening 52 while the second adjustable slide 42 can be positioned at least partially within a second opening 54. The first opening 52 and second opening 54 can extend longitudinally at least partially along the length of the base portion 26. In the illustrated example, the first opening 52 extends generally parallel to and colinear with the second opening 54, such that the first opening 52 and second opening 54 are positioned end to end. In other examples, the first opening 52 and second opening 54 can include a single, elongated opening as opposed to the two openings, as illustrated. Likewise, the first opening 52 and second opening 54 could be longer or shorter in length, wider or narrower in width, etc.

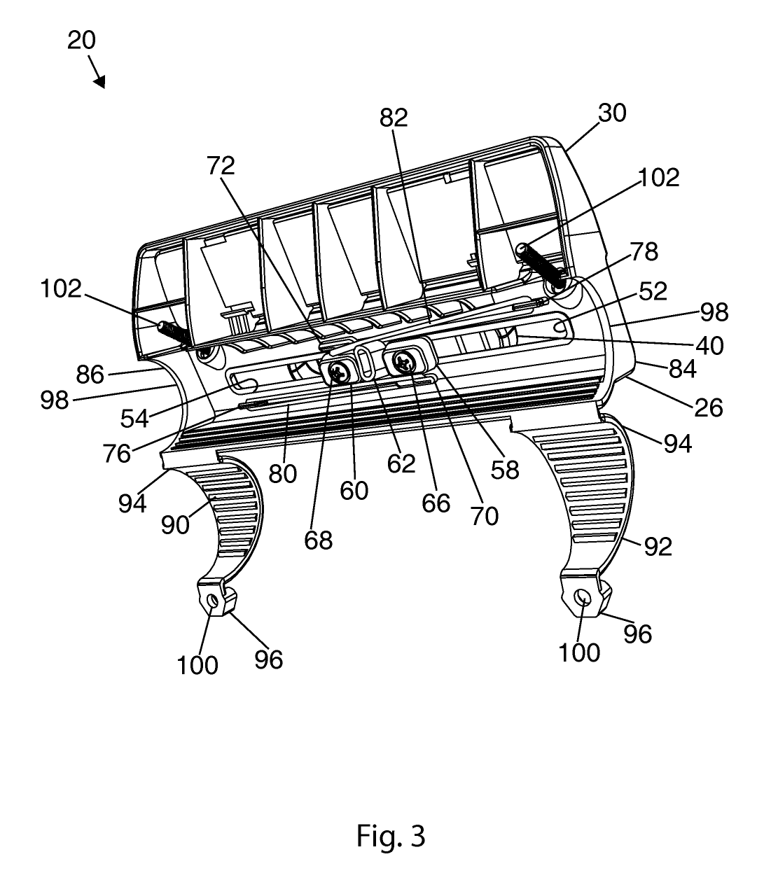

Turning now to FIG. 3, a rear perspective view of the holding device 20 is illustrated. In this example, a rear side of the holding device 20 is shown, with this rear side being disposed on an opposite side of the holding device 20 from the front side (illustrated in FIG. 2).

The first adjustable slide 40 and second adjustable slide 42 (obscured from view in FIG. 3) can include a first holding structure 58 and a second holding structure 60, respectively. The first holding structure 58 can be positioned within the first opening 52 while the second holding structure 60 can be positioned within the second opening 54. In this example, each of the first holding structure 58 and second holding structure 60 defines a larger cross-sectional size than a size (e.g., width) of the first opening 52 and second opening 54. As such, the first holding structure 58 is generally limited from passing through the first opening 52 while the second holding structure 60 is generally limited from passing through the second opening 54.

The first holding structure 58 and second holding structure 60 can be attached to the first adjustable slide 40 and second adjustable slide 42, respectively, in any number of ways. In the illustrated example, the first holding structure 58 and second holding structure 60 are attached to the first adjustable slide 40 and second adjustable slide 42, respectively, by a first fastener 66 and second fastener 68. The first fastener 66 and second fastener 68 can include any number of structures, including, for example, screws, nuts, bolts, nails, adhesives, mechanical locking features, bonding, or the like. Indeed, the illustrated attachment (e.g., screw) is not intended to be limiting, as any number of fasteners 66, 68 are envisioned. Thus, the first and second adjustable slides 40, 42 have an entrapment or constrained condition relative to the base portion 26.

The first holding structure 58 and second holding structure 60 can be separated from each other by an engagement portion 62. In this example, the engagement portion 62 is positioned between the first holding structure 58 and second holding structure 60 and, likewise, between the first opening 52 and second opening 54. The engagement portion 62 can be attached to the rear side of the base portion 26. In some examples, the engagement portion 62 is separately attached (e.g., with a screw, nut, bolt, adhesive, etc.) to the base portion 26. In other examples, the engagement portion 62 can be formed with/molded to the base portion 26, such that the engagement portion 62 and base portion 26 are one-piece formed. The engagement portion 62 can contact/abut the first holding structure 58 on one side and the second holding structure 60 on an opposing second side so as to limit inward motion of the holding structures.

The first holding structure 58 and second holding structure 60 can include a first attachment portion 70 and a second attachment portion 72, respectively. The first attachment portion 70 and second attachment portion 72 each define an extension, protrusion, outcropping, or the like. For example, the first attachment portion 70 can extend outwardly from the first holding structure 58 while the second attachment portion 72 can extend outwardly from the second holding structure 60. In the illustrated example, the attachment portions 70, 72 each define hook-shaped structures, though the attachment portions 70, 72 are not so limited.

The holding device 20 can include a first base attachment structure 76 and a second base attachment structure 78. The first base attachment structure 76 and second base attachment structure 78 each define an extension, protrusion, outcropping, or the like that extend outwardly from the rear side of the base portion 26. In one example, each of the first base attachment structure 76 and second base attachment structure 78 define hook-shaped structures having openings facing away from the engagement portion 62 (i.e., facing away from a center of the base portion 26.

The holding device 20 can include at least one adjustment device positioned within the base portion 26. In an example, the at least one adjustment device includes a first biasing adjustment device 80 and a second biasing adjustment device 82. The first adjustment device 80 can be attached at one end to the first base attachment structure 76 and at an opposing second end to the first attachment portion 70. The second adjustment device 82 can be attached at one end to the second base attachment structure 78 and at an opposing second end to the second attachment portion 72. The first adjustment device 80 and second adjustment device 82 can be attached to the respective base attachment structures and attachment portions in any number of ways, such as by being received within an interior portion of the base attachment structures and attachment portions, or the like. In this example, the first adjustment device 80 extends from a first end 84 of the base portion 26 towards a center of the base portion 26. The second adjustment device 82 extends from an opposing second end 86 of the base portion 26 towards a center of the base portion 26.

The first adjustment device 80 and second adjustment device 82 can be formed of any number of materials. In one example, the adjustment devices 80, 82 can include a resilient, flexible material, such as an elastomer-like material (e.g., rubber, elastic material, etc.). In general, the adjustment devices 80, 82 can flex and resiliently elongate in length in response to movement of the first holding structure 58 and second holding structure 60. The adjustment devices 80, 82 will normally bias the first holding structure 58 and second holding structure 60 (and, thus, the adjustable slides 40, 42) towards a center of the base portion 26 and into engagement/contact with the engagement portion 62. However, the adjustable slides 40, 42 can be moved apart and separated, with the first adjustment device 80 and second adjustment device 82 each flexing and elongating in length. As such, the adjustment devices 80, 82 will function to bias the adjustable slides (e.g., first adjustable slide 40 and second adjustable slide 42) towards each other so as to support the mobile device 22 between the adjustable slides. This biasing will center the first adjustable slide 40 and second adjustable slide 42 and, thus, the mobile device 22 supported by the holding device 20.

The holding device 20 can further include one or more securing devices for attaching the holding device 20 to the cart handle 12 of the shopping cart 10. The securing devices can include, for example, a first securing device 90 and a second securing device 92. The first securing device 90 and second securing device 92 can be disposed at opposite ends of the holding device 20 from each other. In other examples, however, the first securing device 90 and second securing device 92 are not limited to this position, and instead could be positioned closer towards the longitudinal center of the holding device 20, or the like.

The first securing device 90 and second securing device 92 are each movably attached with respect to the base portion 26. The first securing device 90 and second securing device 92 each extend between a first end 94 and an opposing second end 96. In this example, the first securing device 90 and second securing device 92 are pivotable with respect to the base portion 26, with the first ends 94 of the first securing device 90 and second securing device 92 being attached to the base portion 26. The first securing device 90 and second securing device 92 each have a generally concave shape such that an inner surface of the securing devices generally matches a shape of the cart handle 12. The base portion 26 likewise has recessed portions 98 that also match the shape of the cart handle 12. As such, the securing devices can be closed onto the cart handle 12, such that the cart handle 12 is received within an interior portion between the first securing device 90 and one of the recessed portions 98 and the second securing device 92 and the other of the recessed portions 98. By receiving the cart handle 12 within the interior portion defined by the first securing device 90 and second securing device 92, the base portion 26 can be attached to the cart handle 12. It is to be appreciated that the securing devices 90, 92 and recessed portions 98 are not limited to the illustrated size/shape. Rather, in other examples, the securing devices 90, 92 and recessed portions 98 could be sized/shaped to match any number of cross-sectional sizes/shapes of the cart handle 12 (e.g., oval shapes, square shapes, rectangular shapes, etc.).

The first securing device 90 and second securing device 92 can be removably attached at their respective second ends 96 to the base portion 26. In one example, the first securing device 90 and second securing device 92 can include an opening 100 disposed at the second end 96. The opening 100 is sized and shaped to receive a corresponding fastening structure 102 supported by the base portion 26. In this example, the second ends 96 of the first securing device 90 and second securing device 92 can be moved into proximity with the base portion 26 such that the fastening structures 102 extend through the openings 100. A second fastening structure (e.g., nut, washer, etc.) can be attached (e.g., threaded onto) the fastening structure 102 so as to limit detachment of the opening 100 from the fastening structure 102. It is to be appreciated, however, that the securing devices 90, 92 are not limited to the aforementioned attachment means to the base portion 26. In other examples, the securing devices 90, 92 could be attached at their second ends 96 to the base portion 26 by means of other types of mechanical fasteners, snap fit means, adhesives, bonding, or the like.

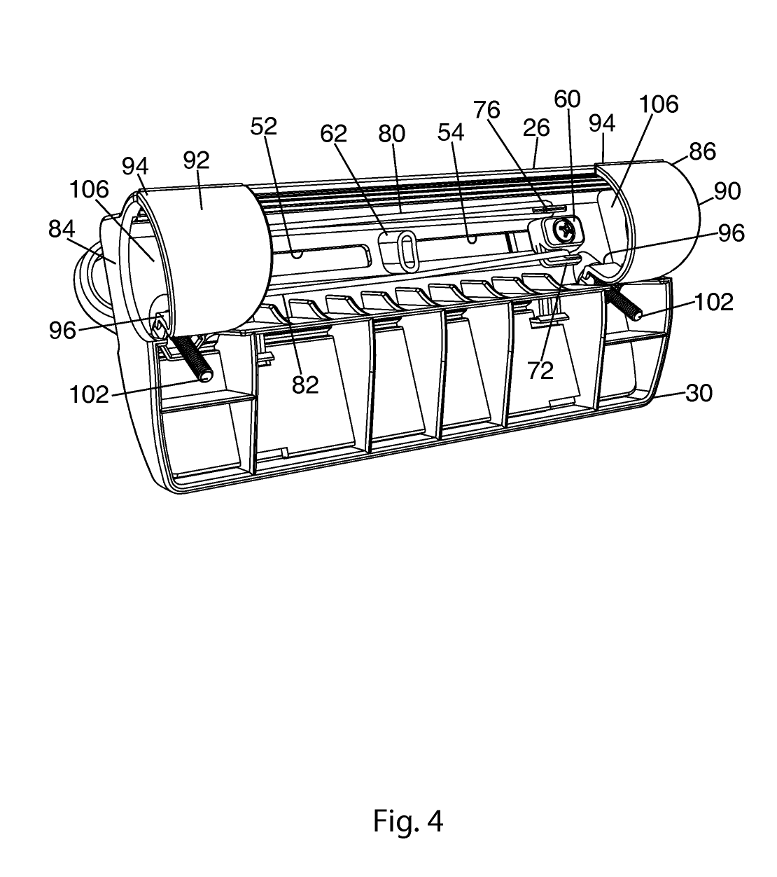

Turning now to FIG. 4, a second example rear perspective view of the holding device 20 is illustrated. It is to be appreciated that in this example, the supporting portion 30 is oriented in a downward direction as opposed to being oriented in an upward direction in FIG. 3. This changed orientation is for illustrative purposes and to more clearly depict portions of the holding device 20 that may normally be obstructed from view.

The securing devices 90, 92 can be moved to the closed position. In this closed position, the fastening structures 102 can pass through the openings 100 at the second ends 96 of the securing devices 90, 92. As such, the securing devices 90, 92 are closed onto the base portion 26 to define an interior portion 106 that is sized/shaped to receive the cart handle 12.

Referring still to FIG. 4, the first holding structure 58 (not shown, obstructed by second securing device 92) and second holding structure 60 can be moved apart to cause similar movement of the first adjustable slide 40 and second adjustable slide 42. For example, the first holding structure 58 is movable with respect to the first opening 52 in a direction away from the engagement portion 62 (e.g., towards the first end 84 of the base portion 26). Similarly, the second holding structure 60 can be moved with respect to the second opening 54 in a direction away from the engagement portion 62 (e.g., towards the second end 86 of the base portion 26). Accordingly, this movement of the holding structures 58, 60 will cause identical movement of the adjustable slides 40, 42, such that the adjustable slides 40, 42 can accommodate mobile devices 22 of varying sizes and orientations (e.g., landscape, portrait, etc.).

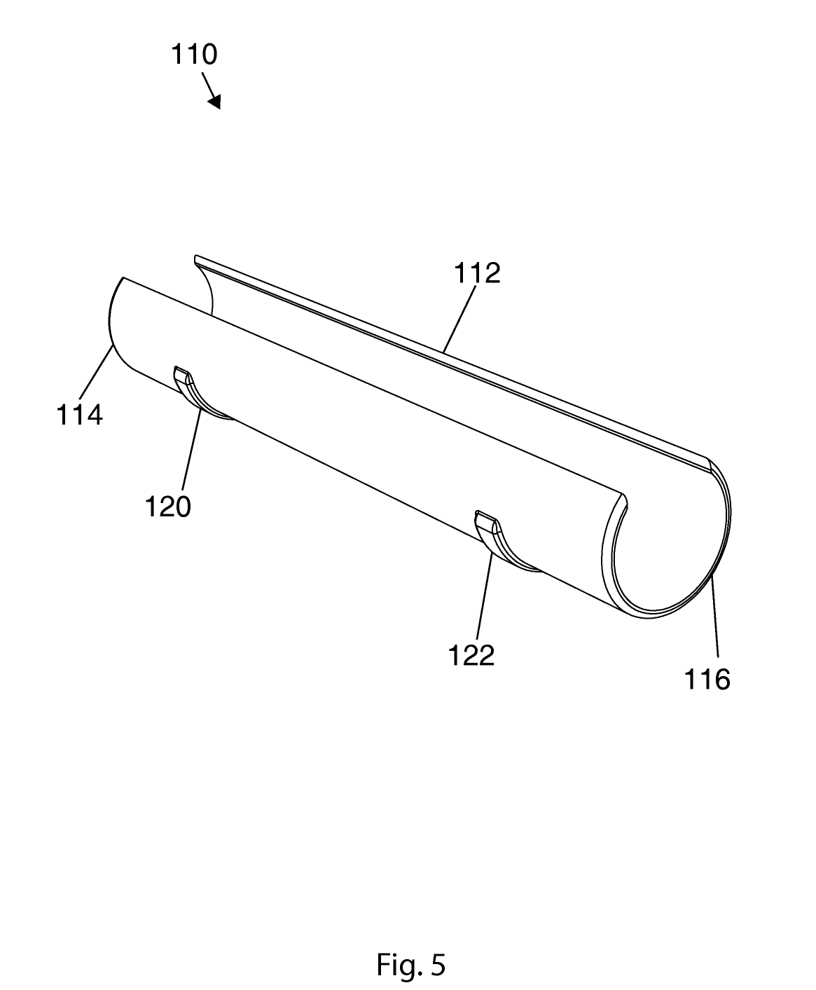

Turning now to FIG. 5, an adapter structure 110 can be provided in association with the holding device 20 and the cart handle 12. It is to be appreciated that the adapter structure 110 need not be provided in all examples, and may only be present in some examples so as to assist in securing the holding device 20 to the cart handle 12. As such, the holding device 20 could be attached to the cart handle 12 with or without the adapter structure 110. In general, the adapter structure 110 functions by accommodating for cart handles 12 of varying sizes and, thus, allowing for the holding device 20 to be non-movably attached to the cart handle 12.

The adapter structure 110 is an elongated, substantially linearly extending structure that can be positioned radially between the cart handle 12 at an inner portion and the holding device 20 at an outer portion. In an example, the adapter structure 110 includes an elongated opening 112. The adapter structure 110 can be formed of a material that is flexible, such that the adapter structure 110 can be flexed outwardly to enlarge the elongated opening 112. As such, the adapter structure 110 can be selectively attached and detached from the cart handle 12 by moving the cart handle 12 in/out of the elongated opening 112.

The adapter structure 110 extends between a first end 114 and an opposing second end 116. The adapter structure 110 has a generally cylindrical shape in the illustrated example, though the adapter structure 110 is not so limited. Rather, in other examples, the adapter structure 110 could have other cross-sectional shapes, such as an oval cross-sectional shape, quadrilateral (e.g., rectangular, square, etc.) cross-sectional shape, or the like. The adapter structure 110 is not limited to the illustrated size, and in other examples, could be longer or shorter in length and/or could have a larger or smaller cross-sectional size.

The adapter structure 110 can be received within the interior portion 106 of the holding device 20. To assist in limiting movement (e.g., longitudinal. etc.) of the adapter structure 110 with respect to the holding device 20, the adapter structure 110 can include one or more alignment structures. In an example, the one or more alignment structures include a first alignment structure 120 and a second alignment structure 122. The first alignment structure 120 and second alignment structure 122 each define an outwardly/radially projecting extension that each extend from an outer surface of the adapter structure 110. The first alignment structure 120 and second alignment structure 122 can contact/engage portions of the holding device 20 to limit movement (e.g., longitudinal, etc.) of the adapter structure 110. In one example, the first alignment structure 120 can contact/engage the first securing device 90 while the second alignment structure 122 can contact/engage the second securing device 92. As such, the adapter structure 110 is generally limited from moving with respect to the holding device 20.

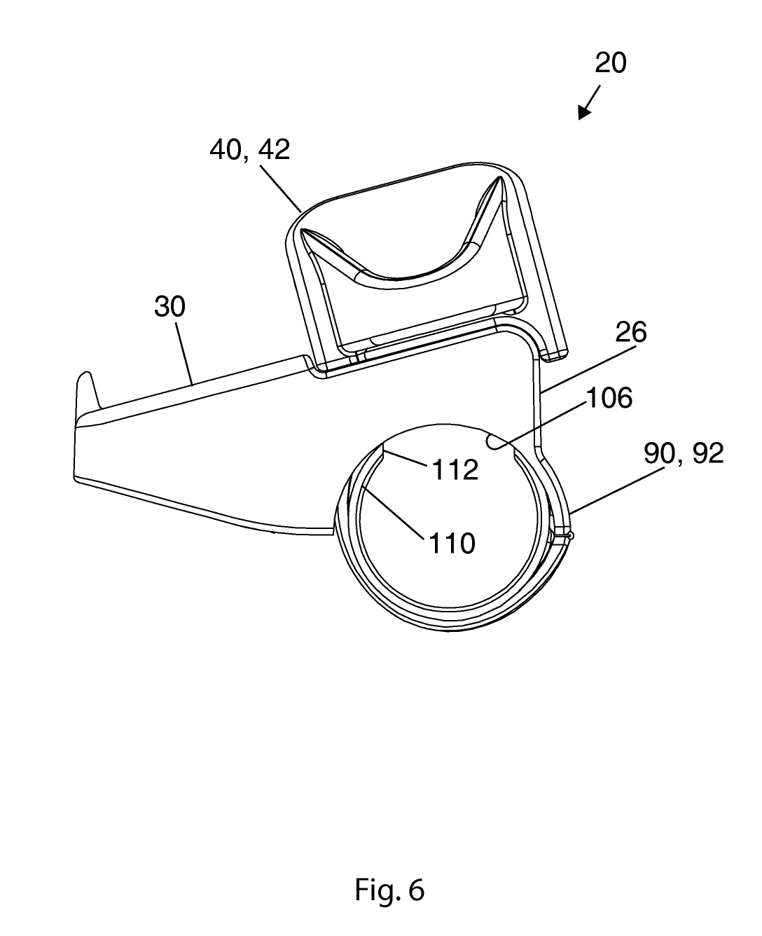

Tuning now to FIG. 6, an example of the adapter structure 110 being received by the holding device 20 is illustrated. In this example, the adapter structure 110 can receive the cart handle 12 (not illustrated in FIG. 6) within an interior portion of the adapter structure 110. The adapter structure 110 can be used for any number of reasons. In one possible example, the adapter structure 110 can be used to accommodate for a size mismatch between the cart handle 12 and the holding device 20. In such an example, the adapter structure 110 can receive the cart handle 12 within an interior of the adapter structure 110. The adapter structure 110 can likewise be received within the interior portion 106 of the holding device 20. As such, the adapter structure 110 functions to minimize the size mismatch between the interior portion 106 of the holding device 20 and the cart handle 12. By minimizing this size mismatch, the holding device 20 can more securely grip/attach to the cart handle 12, thus reducing the likelihood of inadvertent movement (e.g., longitudinal movement, rotational movement, etc.) of the holding device 20.

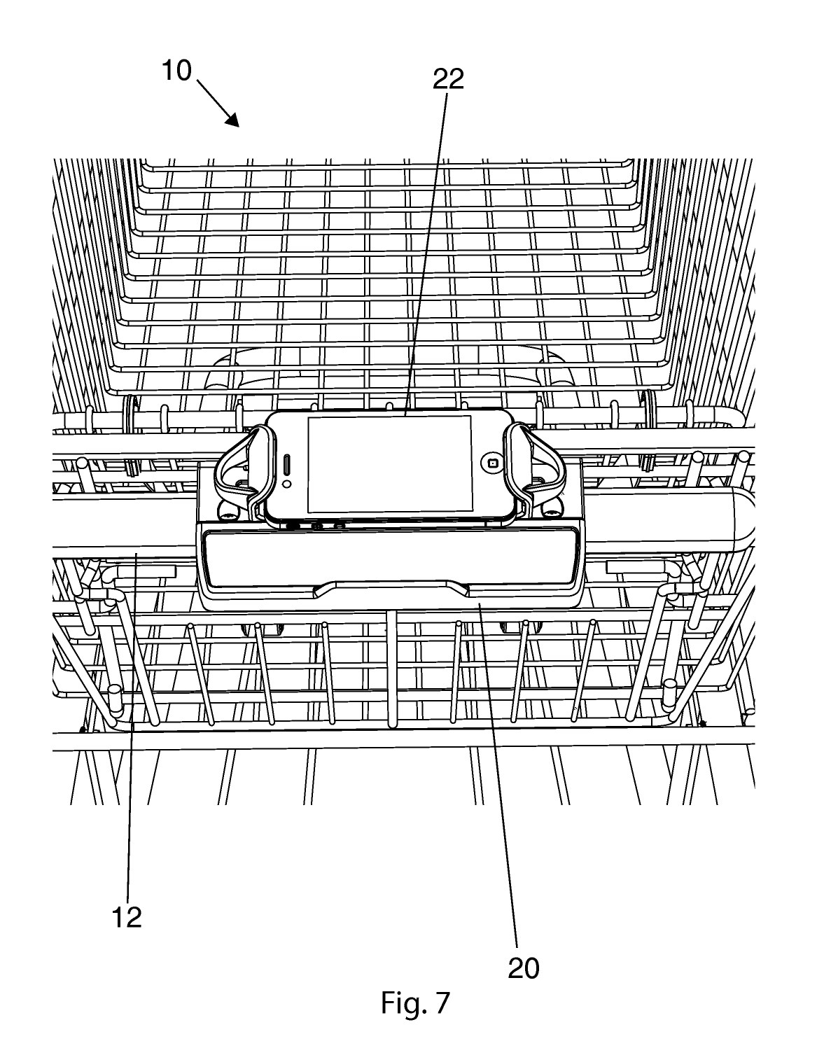

Tuning now to FIG. 7, an example of the holding device 20 is illustrated that is similar to FIG. 1. In this example, however, the mobile device 22 can be supported in a landscape orientation, as opposed to the portrait orientation of FIG. 1. To support the mobile device 22 in the landscape orientation, the first adjustable slide 40 and second adjustable slide 42 can be moved apart in an identical manner as described above with respect to FIGS. 3 and 4. With the first adjustable slide 40 and second adjustable slide 42 being separated, the mobile device 22 can be inserted and supported therebetween. The mobile device can therefore be gripped/held, and is generally limited from inadvertently falling from the holding device 20.

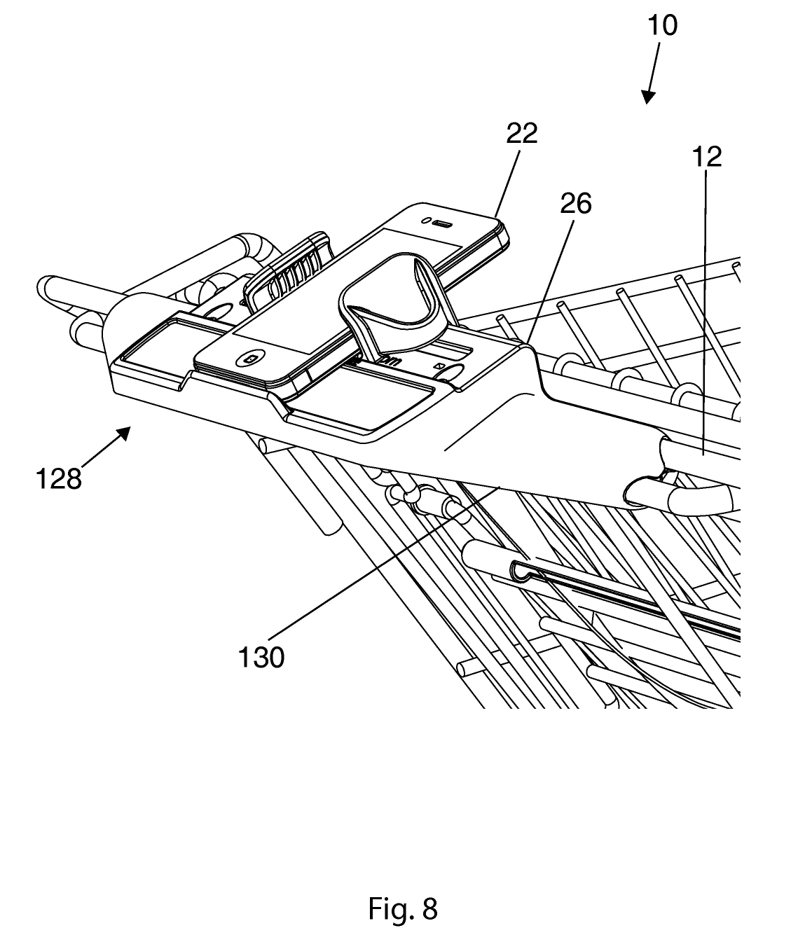

Turning now to FIG. 8, a second example holding device 128 is illustrated. In this example, the second holding device 128 can support the mobile device 22 in a similar/identical manner as described above. In particular, the second holding device 128 supports the mobile device 22 in the portrait orientation (as shown) or the landscape orientation. The second holding device 128 can include a number of structures that are identical to the holding device 20 described above, including the base portion 26, supporting portion 30, first and second adjustable slides 40, 42, etc. As such, these structures need not be described in detail again.

The second holding device 128 can be fixedly attached to the shopping cart 10 in this example. The second holding device 128 includes, for example, an attachment portion 130. The attachment portion 130 is integrally formed/molded with the base portion 26. As such, the attachment portion 130 is generally one-piece formed with the base portion 26. To assist in attaching the second holding device 128 and the shopping cart 10, the attachment portion 130 can be molded to the cart handle 12. In one example, the attachment portion 130 can initially be in a pliable state, such that the attachment portion 130 can be molded to/formed around the cart handle 12 (or multiple cart handles 12, as illustrated). It is to be appreciated that the attachment portion 130 can be molded to/formed around the cart handle 12 in any number of ways. As such, this molding/forming with of the attachment portion 130 to the cart handle 12 will limit/prevent unintended movement of the second holding device 128 with respect to the shopping cart 10.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A holding device for attachment to a shopping cart, the holding device including:
a base portion attached to a cart handle of the shopping cart;
a pair of adjustable slides movably attached with respect to the base portion, the adjustable slides defining an interior portion configured to receive a mobile device; and
at least one adjustment device positioned within the base portion and attached to each of the adjustable slides, the at least one adjustment device configured to bias the adjustable slides towards each other so as to support the mobile device between the adjustable slides.

2. The holding device of claim 1, wherein the at least one adjustment device includes a first adjustment device and a second adjustment device.

3. The holding device of claim 2, wherein a first holding structure is attached to one of the adjustable slides and a second holding structure is attached to the other of the adjustable slides.

4. The holding device of claim 3, wherein the first holding structure is movable with respect to a first opening in the base portion and the second holding structure is movable with respect to a second opening in the base portion.

5. The holding device of claim 4, wherein the first holding structure includes a first attachment portion configured to attach to the first adjustment device, the second holding structure including a second attachment portion configured to attach to the second adjustment device.

6. The holding device of claim 5, wherein the first adjustment device is attached, opposite the first attachment portion, to a first base attachment structure supported by the base portion and the second adjustment device is attached, opposite the second attachment portion, to a second base attachment structure supported by the base portion.

7. The holding device of claim 6, wherein the first adjustment device and second adjustment device bias the adjustable slides towards each other.

8. The holding device of claim 1, further including at least one securing device movable with respect to the base portion, the at least one securing device being configured to receive the cart handle of the shopping cart to attach the base portion to the cart handle.

9. The holding device of claim 8, wherein the at least one securing device includes a first securing device and a second securing device, the first securing device and the second securing device each being pivotable with respect to the base portion to define an interior portion configured to receive the cart handle.

10. The holding device of claim 1, wherein the base portion is integrally formed with the cart handle of the shopping cart.

11. A holding device for attachment to a shopping cart, the holding device including:
a base portion;
a pair of adjustable slides movably attached with respect to the base portion, the adjustable slides defining an interior portion configured to receive a mobile device;
at least one adjustment device attached to each of the adjustable slides and being configured to bias the adjustable slides towards each other; and
at least one securing device movably attached with respect to the base portion, the at least one securing device receiving a cart handle of the shopping cart to attach the base portion to the cart handle.

12. The holding device of claim 11, wherein the at least one securing device includes a first securing device and a second securing device, the first securing device and second securing device each being pivotable with respect to the base portion to define an interior portion configured to receive the cart handle.

13. The holding device of claim 12, wherein each of the first securing device and second securing device include a first end that is pivotable with respect to the base portion and an opposing second end that is removably attachable to the base portion.

14. The holding device of claim 11, further including an adapter structure that matches a shape of the cart handle, the adapter structure being configured to receive the cart handle within an interior portion of the adapter structure.

15. The holding device of claim 14, wherein the securing device is configured to receive the adapter structure when attaching the base portion to the cart handle.

16. A shopping cart including:
a base portion integrally formed with a cart handle of the shopping cart;
a pair of adjustable slides movably attached with respect to the base portion, the adjustable slides defining an interior portion configured to receive a mobile device; and
at least one adjustment device positioned within the base portion and attached to each of the adjustable slides, the at least one adjustment device configured to bias the adjustable slides towards each other.

17. The shopping cart of claim 16, wherein the pair of adjustable slides are movable towards and away from each other so as to support the mobile device within the interior portion in a plurality of orientations.

18. The shopping cart of claim 17, wherein the adjustable slides are movable to support the mobile device in a portrait orientation.

19. The shopping cart of claim 17, wherein the adjustable slides are movable to support the mobile device in a landscape orientation.

20. The shopping cart of claim 16, wherein the base portion is non-removably attached to the cart handle of the shopping cart.
